(19) United States
(12) Patent Application Publication
(10) Pub. No.: US 2015/0259222 A1
(43) Pub. Date: Sep. 17, 2015

(54) Electrolysis Remediation Device and Method

(71) Applicant: Kyle Smith, Leesburg, GA (US)

(72) Inventor: Kyle Smith, Leesburg, GA (US)

(21) Appl. No.: 14/214,881

(22) Filed: Mar. 15, 2014

(51) Int. Cl. C02F 1/461

(52) U.S. Cl. CPC C02F 1/461

(57) ABSTRACT

The current invention is an electrolysis remediation device and method that will act to saturate an area of influence with oxygen and/or hydrogen, which can easily be placed easily into a contaminated medium with minimum intrusiveness and power requirements. A variety of soil and groundwater contaminants are more readily broken down in an oxygen rich environment. Increasing the oxygen content of the soil and groundwater has been used to address a broad range of volatile and semivolatile contaminants including many of the contaminants associated with fuels, BTEX compounds and chlorinated solvents. Hydrogen is also widely recognized as a required key electron donor for the biologically mediated remediation of chlorinated compounds.

### CROSS-REFERENCE TO RELATED APPLICATIONS

Provisional Application No. 61/793,261 with Confirmation # 4737

### STATEMENT REGARDING FEDERALLY SPONSORED RESEARCH OR DEVELOPMENT

Not applicable

### REFERENCE TO SEQUENCE LISTING, A TABLE, OR A COMPUTER PROGRAM LISTING COMPACT DISK APPENDIX

Not applicable

### BACKGROUND OF THE INVENTION

The present invention is in the technical field of electrolysis. More particularly, the present invention is in the technical field of utilizing electrolytic generation of oxygen and/or hydrogen in order to increase the oxygen and/or hydrogen content in the groundwater to aid in the remediation of contamination. This invention relates to the improvement of an electrolysis remediation device and method.

There is often a need to reduce the levels of the many different contaminants that may be found in groundwater and to do this in a nonintrusive way in-situ. In the recent past, there have been many methods and techniques used, but perhaps the most widely available and applicable technologies aim to increase the oxygen content of the soil or groundwater in order to gain both active and passive breakdown of the contaminant load. A variety of soil and groundwater contaminants are more readily broken down in an oxygen rich environment. Increasing the oxygen content of the soil and groundwater has been used to address a broad range of volatile and semivolatile contaminants including many of the contaminants associated with fuels, BTEX compounds and chlorinated solvents. Hydrogen is widely recognized as a required key electron donor for the biologically mediated remediation of chlorinated compounds.

The most common method of increasing the oxygen content of groundwater is by sparging the medium with air or oxygen. This is typically done by enlisting motors and pumps to push air or oxygen into the saturated zone, where the air then traverses both horizontally and vertically through the many crevices and capillaries in order to both volatize groundwater contaminants and to promote biodegradation in saturated and unsaturated soil zones by the increase of subsurface oxygen content. Excess volatilized vapors may then migrate into the vadose zone where they can be extracted via vacuum and removed. Airsparging with the primary goal of highlighting the bioremediation process, both below and above the water table, obtained with the increase in oxygen concentration versus the volatilization process of contaminants is typically referred to as biosparging, although the two terms are often used interchangeably. Sites with homogeneous, relatively permeable soil conditions are more favorable for air sparging techniques due to greater likelihood of contact between the sparged air and contaminated media and the greater effective migration of the volatized contaminants. Other site conditions that are favorable to air sparging techniques are those sites with large thicknesses of saturation and depth to groundwater.

Air sparging systems must be properly designed with air flow rates and pressures that correspond to each site in order to provide adequate coverage of the area of contamination while at the same time minimizing uncontrolled release of unmanageable amounts of volatized compounds into the atmosphere. Horizontal Well Soil Vapor Extraction systems are typically used in conjunction with air sparging to help safeguard against volatile contaminant release, and air sparging helps increase the effectiveness of standalone soil vapor extraction techniques since the volatilization can overcome the simple diffusion limited extraction of VOCs from groundwater and it can also be effective in treating contamination found in the capillary fringe and below the water table.

A majority of the conventional air sparging systems utilize the injection of atmospheric oxygen, which generally contains just a little over 20.5% oxygen. These systems, although proven effective at increasing the oxygen content of the saturated and unsaturated soil structure are limited by this oxygen percentage of ambient air and will often have a difficult time raising the oxygen to a supersaturated level. It has been shown that if you increase the oxygen content of the soil column then there will be a subsequent acceleration of volatilization and bioremediation of contaminants, so it should be understood that a device is needed that can achieve higher levels of oxygen saturation in both all zones found in the soil columns.

It is therefore an objective of the present invention to provide an improved device and method for the oxygenation and/or hydrogenation of the different soil zones.

### SUMMARY OF THE INVENTION

The present invention is an apparatus and method for the electrolysis of water.

The invention may be conceptualized as a device that will provide for the electrolysis of water in contaminated environments with the goal of achieving a high oxygen and/or hydrogen loading of the saturated and unsaturated soil zones. The production of oxygen and hydrogen by the hydrolysis of water is well known, and the breakdown of water molecules occurs when a current is applied across a cathode and an anode in an aqueous media. This current may be provided by any DC current source and the resultant reaction has hydrogen gas produced at the cathode and oxygen gas produced at the anode. The stoichiometric representations of the reaction are easily found in current literature.

When these gases form in a soil matrix the gases will rise vertically and expand horizontally out through the microfractures found in the soil and will establish an area of influence at which the oxygen and/or hydrogen content will be effectively raised. This area of influence will be greatly dependent on many outside factors such as temperature, soil composition, and water contaminants present, and also on controllable factors such as current applied, the size of the hydrolysis device and the effectiveness of the anode and cathode. Many different anode and cathode compositions and combinations are currently available and have been explored in previous art. Cathodes of a metal or metallic oxide group such as platinum, titanium, iridium, palladium, manganese, tantalum, molybdenum, cobalt, tungsten, lead, osmium, nickel, iron, rhodium and rhenium are some mentioned in literature as being effective in hydrolysis systems. Anodes are also formed with some of the same metals and metallic oxides listed and both electrodes can be made from alloys of the above metals along with co-deposited oxides on different substrates. Some of the more effective models have shown that an anode composed of platinum with iridium oxide and a stainless steel mesh cathode separated by a critical distance to be the most effective.

The current invention will provide a device whose primary objective is to provide an electrolytic device that shall serve as an effective oxygen generator in an aqueous media. Molecular oxygen radicals will be produced and will react with other oxygen radicals to form molecular oxygen. The electrodes may be of any number of combinations of the above listed metal or metal oxide combinations and shall be separated by a critical distance. These anodes and cathodes may be contained in protected shell that will still allow for the exposure of the electrodes to the aqueous media. Controls and sensors shall be a part of the device in order to regulate the timing and necessary current and in order to detect different chemical parameters or effectiveness of the device. The size and voltage requirements will be determined by the site specific needs for the device.

In one embodiment of the current invention, the anode and cathode arrangement will be placed in a tubular housing that shall serve as a protective case. This housing shall have exposure windows that will allow for the electrodes to come into contact with the aqueous media. This housing may be placed into the saturated zone of soil in many different ways, however the device will allow for the placement of the device using all of the common drilling means available today including but not limited to DPT (Direct Push Technology), soil boring, and conventional soil drilling. The device may be placed directly into a soil boring hole and just left in place within the saturated zone when the drilling shafts are removed. In another embodiment, the invention may be placed into an existing well by simply lowering the device down in the well and into the groundwater. In another embodiment, the current invention may be made a part of the portion of a Groundwater Monitoring Well's wall and be installed at the same time as the well itself. In another embodiment, the cathode and anode separated by a critical distance may be formed into sheets that can either be rigid or flexible for the purpose of layering under an area that would need benefit from an increased oxygen level. In this embodiment, the sheet could also be arranged in a vertical position to act as kind of a downgradient oxygen curtain. In all of these embodiments the goal is create an oxygenation and/or hydrogenation system with lower power demands and higher effectiveness of typical sparging systems.

The invention may also be conceptualized as a method for the oxygenation or hydrogenation of a contaminated soil matrix. The method produces oxygen and/or hydrogen for the purpose of raising the oxygen and/or hydrogen level in compromised/contaminated soil zones with the hope of aiding volatilization and bioremediation of the hazardous compounds. The method comprises the steps of (1) providing an energy source to two electrodes situated in an aqueous media or saturated soil zone; (2) in response to this energy input, elemental hydrogen and oxygen form at the anodes and cathodes; (3) allowing for the release of oxygen and/or hydrogen into the contaminated media aiding in the remediation of groundwater and connected soil zones. The invention may also be conceptualized as a preventive method for the contamination different areas in that it may be installed without and/or prior to contamination being present.

It is also within the scope of this invention to cover various models and energy demands depending both on the need for oxygen and/or hydrogen generation or in place power constraints. The current invention may be powered by a variety of sources including but not limited to generators, electric power grids, batteries and solar power.

In one embodiment, the device could just simply be used as a preventative measure to potential contamination or potential migration of contamination. In another embodiment the device could be utilized to limit the actual migration of contaminants both vertically and horizontally. In another embodiment the device could not only be used to control migration but would actively lead to the volatilization and/or breakdown of contaminants present.

### BRIEF DESCRIPTION OF THE DRAWINGS

FIG. 1 is a front view of one embodiment of a Electrolysis Remediation Device of the present invention.

FIG. 2a is a top view of one embodiment of a Electrolysis Remediation Device of the present invention.

FIG. 2b is a top view of one embodiment of a Electrolysis Remediation Device of the present invention.

FIG. 2c is a side view of one embodiment of a Electrolysis Remediation Device of the present invention.

FIG. 3 is a front view of another embodiment of an example of a Electrolysis Remediation Device of the present invention in use.

FIG. 4 is a front view of another embodiment of an example of an Electrolysis Remediation Device of the present invention in use.

### DETAILED DESCRIPTION OF THE INVENTION

In the following detailed description of the preferred embodiments, reference is made to the accompanying drawings which form a part hereof, and within which are shown by way of illustration specific embodiments by which the invention may be practiced. It is understood that other embodiments may be utilized and structural changes may be made without departing from the scope of the invention.

Turning now to the drawings wherein like numbers refer to like features throughout the drawings, the present invention comprises an electrolysis remediation device and method.

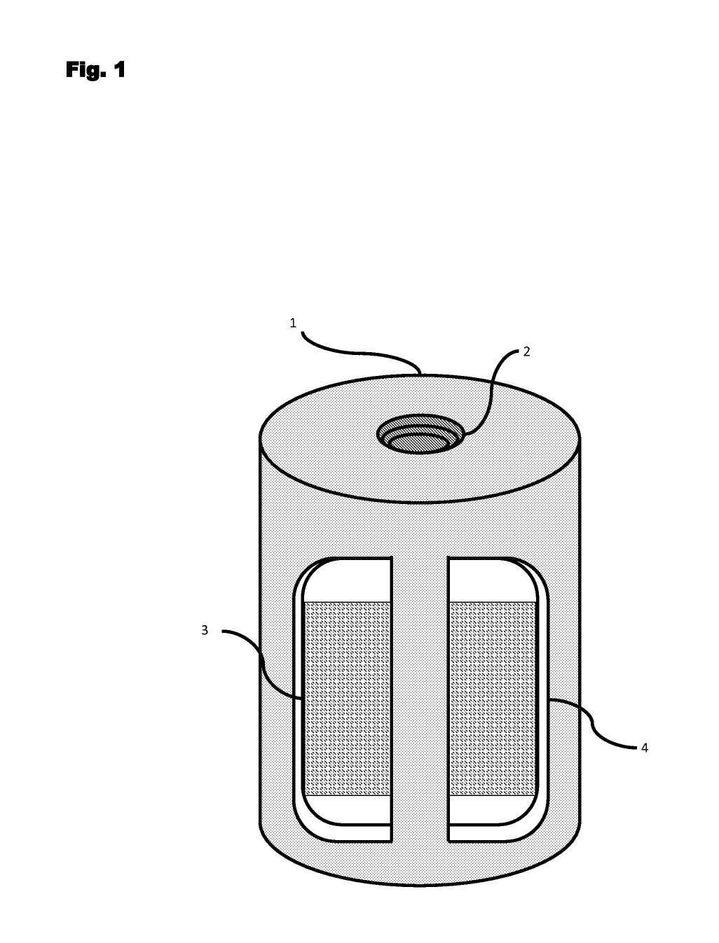

Referring now to the invention in more detail, in FIG. 1 there is shown a front view of a electrolysis remediation device composed of a housing 1 intended to contain the electrode assembly 3. The housing 1 contains one or more open windows 4 that shall serve to allow the exposure of the electrode assembly 3 to the ambient medium and shall have a mounting system 2 to allow for the housing 1 to be inserted into a soil boring at the time of boring and left in place when the boring tubes are removed. This mounting system 2 can be considered to be a bolt hole, screw, clip or any number of ways currently available that allow for two objects to be both temporarily and/or permanently connected. In one embodiment of the current invention both chemical sensors, oxygen and/or hydrogen sensors and temperature sensors can be contained within the housing 1. In this embodiment, control of the device will be via wire that is connected directly to the device and a control panel on the surface. Although in this preferred embodiment of the current invention the electrode assembly 3 is shown to just consist of one screen of stainless steel mesh over one screen of iridium oxide coated platinum, in another embodiment, the electrode assembly can be made of a of plurality anodes and cathodes ‘sandwiched’ together in a variety of different size and composition combinations. In another embodiment the size of the devices can be readily adapted for differing applications and adjustments to the power consumption of the device would allow for different levels of oxygen and/or hydrogen generation. Although in this preferred embodiment of the current invention the mount is shown to be cylindrical and for attachment at the top of the housing 1, however in another embodiment it may be of any number of shape and sizes with different attachment points with the housing 1 primary purpose to serve as a protective sleeve around the electrode assembly 3. In another embodiment, the housing 1 may be adapted to screw or attach directly to a monitoring well tube screen or bottom and may also allow for the vertical transmission of aqueous media through the housing, with windows or just by being open/permeable, the same as it allow horizontal transmission in the FIG. 1 with the shown open windows 4 on the side of the housing 1. In another embodiment, the openings or windows 4 may be covered with a water permeable membrane in order to allow aqueous media to come into contact with the electrode assembly 3 but prevent the assembly from being damaged by other contacts. In another embodiment, sensors and controls can be contained separate from the housing 1.

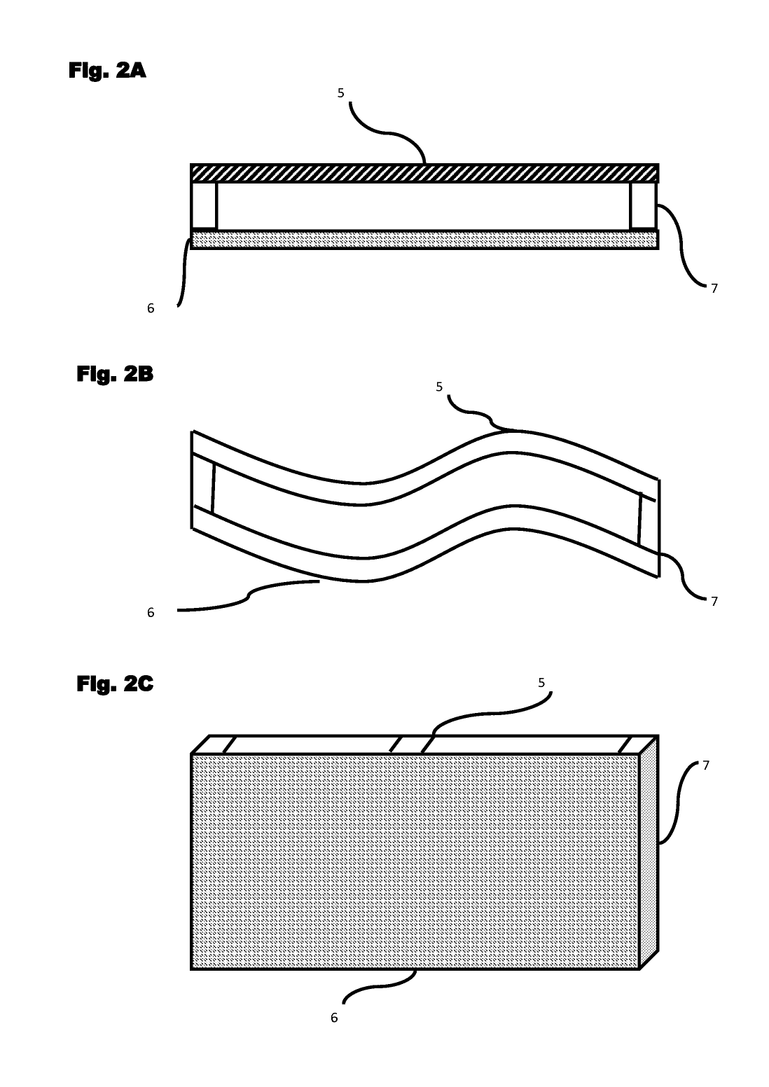

Referring now to the invention shown in FIG. 2a there is shown a top view of the current invention. In this top view embodiment of a portion of the current invention the electrode assembly of FIG. 1 is shown. The oxygen producing anode 5 is shown separated by a critical distance from the hydrogen producing cathode mesh 6. The anode 5 and cathode 6 are held at the proper critical distance by a non-conducting spacer 7 such as nylon that shall also allow for the passage of gas and the mixing of anodic and cathodic water. The mixing of this anodic and cathodic water shall be encouraged so that the waters at each electrode do not become too basic or acidic and therefore overly corrosive to the electrodes. The spacer can be of any nonconductive material such as nylon, fiberglass, polymer or other plastic although it is preferable to have a non-compressible spacer so that the critical distance between the anode 5 and cathode 6 is maintained. In one embodiment of the current invention a means to augment the mixing of the electrode waters could take the form of circulation fans, pumps or motors. In the current invention shown in FIG. 2a the two electrodes are shown to be in a rigid form whereas in the FIG. 2b the cathodes mesh 6 and anode 5 is shown to be in a flexible form. In FIG. 2c the assembly is shown in a side view with the cathode 6 and anode 5 with separation spacers 7. In the embodiments shown in FIG. 2a and FIG. 2b and FIG. 2c the assemblies would be connected to a power and control source for the two electrodes. In this embodiment, an oxygen, hydrogen and temperature sensor along with a control circuit would be used to control the on/off cycles of the electrode assembly.

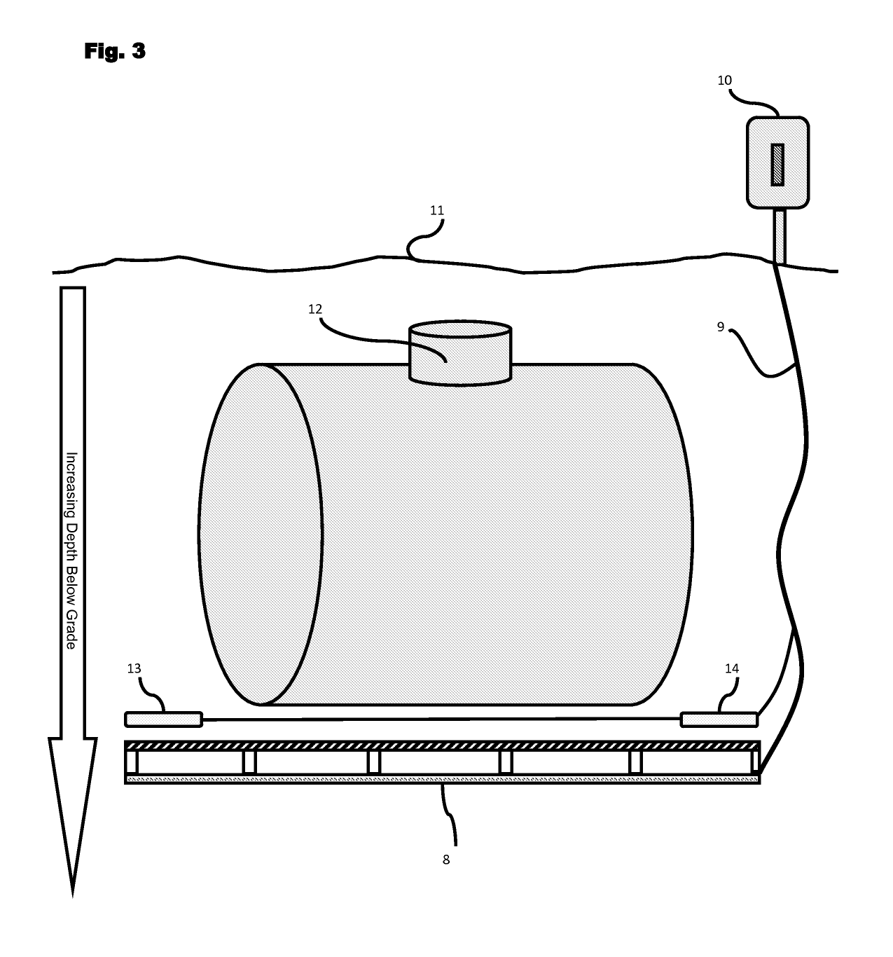

In an example illustration of an embodiment of the current invention shown in FIG. 3, the illustration shown in FIG. 2a, 2b and/or 2c is illustrated as the electrode assembly 8 placed under an underground storage tank (UST) 12 located under the current grade or ground surface 11, and connected to a control unit 10 via a control wire 9. This control wire 9 may also control chemical and temperature sensors 13, 14 that may be necessary for the proper monitoring and regulation of the system. In another embodiment, the sensors 13, 14 may be contained within the electrode assembly 8. In this embodiment, the electrode assembly can either be actively producing oxygen and/or hydrogen or may just be installed as a precaution and only be utilized in the case of contamination.

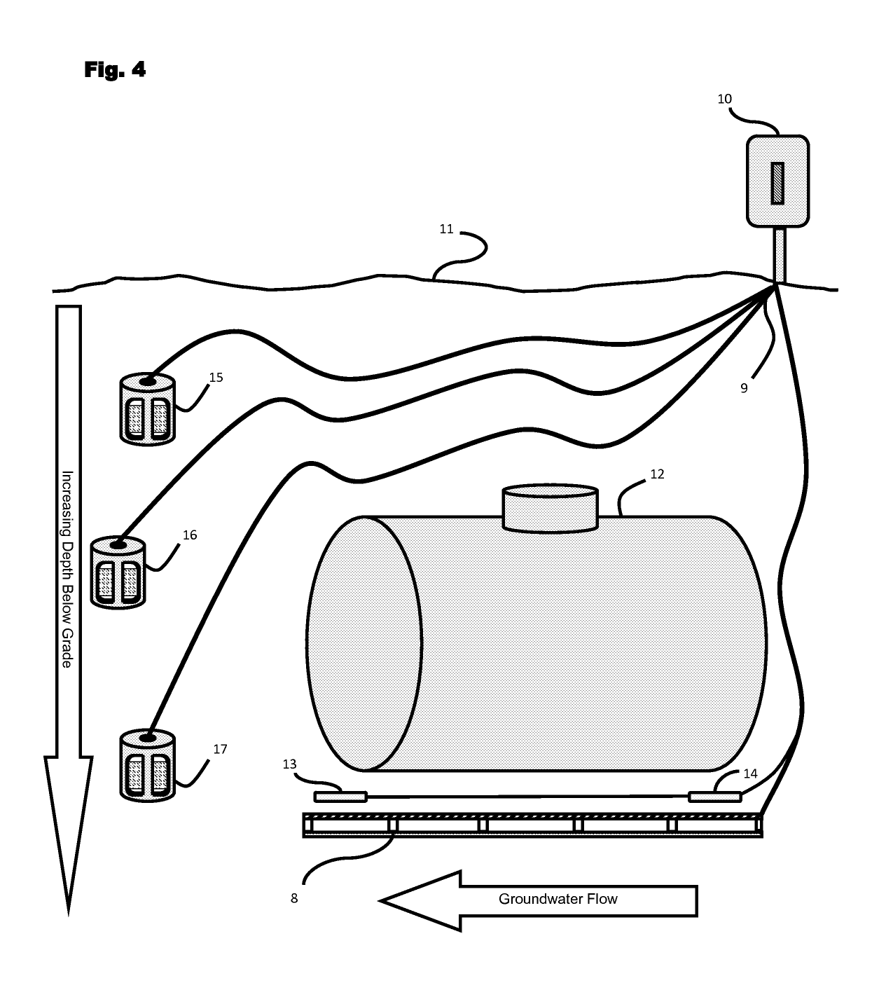

Referring now to FIG. 4, which another example illustration of an embodiment of the current invention, the illustration shown in FIG. 2a, 2b and/or 2c is illustrated as the electrode assembly 8 placed under an underground storage tank (UST) 12 located under the current grade or ground surface 11, and connected to a control unit 10 via a control wire 9. This embodiment of the current invention, also shows the placement of multiple hydrolysis remediation devices 15, 16, 17 as shown and described in FIG. 1 downgradient from the UST 12 at varying depths and locations in order to enhance the area of effective influence. Although in this illustration the current invention is shown to be beneath and downgradient of an underground storage tank, in other embodiments the invention may be place in any area where there is a desire to raise the oxygen and/or hydrogen level of the groundwater and surrounding soils. In another embodiment of the current invention, a direct-push drilling rig or conventional drilling rig can be used to quickly install many of the devices described in FIG. 1.

The advantages of the present invention include, without limitation, is that it provides for a simple yet effective means of oxygen and/or hydrogen generation for the increase in the oxygen and/or hydrogen levels of groundwater and surrounding soils. The mount in one embodiment will help to remediate contaminated groundwater and soil through both volatilization and bioremediation.

In broad embodiment, the present invention is an electrolysis remediation device and method.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiments, methods, and examples, but by all embodiments and methods within the scope and spirit of the invention. Therefore, such variation, combinations and equivalents are within the scope of the appended claims.

The invention claims:

1. An electrolysis remediation device comprising:
an oxygen and hydrogen emitter having both an anode and a cathode separated at a critical distance from one another by a nonconductive spacer contained within a cylindrical housing with exposure windows, holes, slots or screens that will allow the electrodes to come into contact with the aqueous media it is inserted within,
a power source,
a control circuit with electrical communication with the anode and cathode, power source and various sensors.

2. The remediation device of claim 1 wherein the anode and cathode are contained within a non-cylindrical housing.

3. The remediation device of claim 1 wherein the housing has an attachment point or means of attachment to either traditional well drilling setups or direct push technology setups for insertion into the aqueous media.

4. The remediation device of claim 1 wherein the housing has the attachment point or threading necessary to directly attach it to either a temporary or permanent well wall or casing.

5. A method of insertion of the remediation device of claim 1, wherein the device shall have a mounting system that will allow for the device to be either inserted into a soil boring or well drilling hole at the time of boring or drilling and for the device to be left in place when the drilling or boring tubes are removed.

6. A method of insertion of the remediation device of claim 1, wherein the device may be lowered into a soil boring or well after the initial boring or drilling has been completed into the aqueous medium.

7. An electrolysis remediation device comprising:
an oxygen and hydrogen emitter having both an anode and a cathode separated by a critical distance from one another by a nonconductive spacer formed into a sheet housing that can be either rigid or flexible with exposure windows, holes, slots or screens that will allow the electrodes to come into contact with the aqueous media it is placed within,
a power source,
a control circuit with electrical communication with the anode and cathode, power source and various sensors.

8. A method of placement of the sheet housing of claim 7 in a vertical position to act as a form of remediation device ‘curtain’ down gradient of an area of interest.

9. A method of placement of the sheet housing of claim 7 in a horizontal position to act as a form of remediation device ‘blanket’ underneath an area of interest.

10. The electrolysis remediation device of claims 1 and 7, wherein the device has circulation fans, pumps or motors to augment the mixing of aqueous media around the electrodes.

11. The electrolysis remediation device of claims 1 and 7, wherein the device contains a plurality of anodes and a plurality of cathodes.

12. The openings or windows of claims 1 and 7, wherein the openings, slots, windows or screens are covered with a water permeable membrane.

13. The electrolysis remediation device of claims 1 and 7, wherein the chemical and temperature sensors and control circuits that control the on/off cycles of the electrodes are contained within the device housings.

14. The electrolysis remediation device of claims 1 and 7, wherein the chemical and temperature sensors and control circuits that control the on/off cycles of the electrodes are contained separate from the device housings.

15. The device of claims 1 and 7, wherein the devices are connected to a power source separate from the device.

16. The device of claims 1 and 7, wherein the devices have an onboard power source.

17. A method for the remediation of contaminated surrounding aqueous media and soil matrix with the device in claims 1 and 7.

18. A method of utilizing the device in claims 1 and 7 as a precautionary measure to be installed in areas with greater probability of future contamination.

19. A method of utilizing the device in claims 1 and 7 as a means to slow or prevent migration of contamination.
